(19) United States
(12) Patent Application Publication
(10) Pub. No.: US 2007/0094257 A1
(43) Pub. Date: Apr. 26, 2007

(54) File management

(76) Inventor: Kathy Lankford, Caldwell, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/257,533

(22) Filed: Oct. 25, 2005

(51) Int. Cl. G06F 17/30

(52) U.S. Cl. 707/7

(57) ABSTRACT

A method for file management comprising calculating a relevance score for each file of a plurality of files in a file repository and performing a triage process on the files in accordance with the relevance score.

### BACKGROUND

File storage and file sharing is an integral part of computing in today's environment. File management, both on single user computers and complex network systems with file sharing resources, has typically been performed manually, and is a process that is typically performed with less than optimum efficiency. With the growth of increasingly complex computer systems using increasingly complex software products, file management is becoming a area of increasing concern for network administrators.

Often, the management of in-process, constantly changing files can be a difficult task. For example, a proposal might have many drafts before a final document is completed, and often these files are each stored under separate file names (e.g., proposal.doc, Revisedproposal.doc, finalproposal.doc). Assuring the most current document is being viewed can be a difficult task. This difficulty can be further amplified because typically project teams are used to coordinate the software development task. This can result in file revisions by one user of which a second user is often unaware. For example, a team member might draft a proposal. A project manager might edit the proposal, or solicit edits from a second team member. The drafting team member may or may not be aware of these edits, and when he or she later attempts to access the document (e.g., to make revisions), he or she might access the incorrect draft if a newer draft has been saved with a different name. In addition, sometimes a project will be cancelled at some point and, in such cases, the files for the project (often several drafts of each) normally remain stored. The failure to cleanup old, unnecessary files uses storage space and makes locating useful files more difficult.

Typically, in a network system, the numerous files (often including numerous drafts of each) are stored in a designated area, often referred to as a “shared file repository” or “file share.” Keeping the shared file repository organized and in a state that allows for efficient file storage and access can be a difficult task. Typically, configuring and maintaining a shared file repository is the responsibility of a file repository manager. File repository managers can utilize file sharing protocols and software packages, such as SharePoint® by Microsoft, that have been developed to facilitate file sharing, but current file sharing packages do not address the concerns that arise when a shared file repository becomes overly burdened with files, thus increasing storage costs and decreasing the ability to locate particular files efficiently. Additionally, the concerns regarding overly burdened file storage areas are not limited to shared repositories. These issues can be a concern for file storage areas located on individual computing devices as well.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 is a diagram of an exemplary distributed network computer system upon which an embodiment of the present invention can operate.

FIG. 2 is a flow chart of a method for managing files in a file repository in accordance with an exemplary embodiment of the present invention.

FIG. 3 is a flow chart illustrating the steps for determining a relevance score in accordance with an exemplary embodiment of the present invention.

FIG. 4 is a flow chart illustrating the steps involved in configuring an exemplary embodiment of the present invention.

### DETAILED DESCRIPTION

Overview

The exemplary embodiment of the present invention shall be described herein with reference to a share file repository residing in a distributed network. The use of shared file repositories has become commonplace, and the ability to share files among many users is an element that has made client-server networks a popular choice for many organization. It should, however, be understood that the invention may also be practiced on any computing device that stores files (e.g., personal computers) and is not limited to shared file repositories. In such instances, the user of the computing device will typically also function as the file repository manager.

Over time, shared file repositories often become overcrowded with files that are no longer active. Often, a large number of files might remain in a repository that are no longer of value to an organization. For example, older versions of developing files or files representing developments that have been abandoned will remain in the repository. This add to the storage costs associated with maintaining a file repository and also increases the difficulty of locating active files in the repository.

Typically, finding a file in a shared file repository is accomplished by having a user select a particular file from a directory listing provided via a graphical user interface. The files can commonly be listed/sorted by certain criteria. Listing of files is normally done alphabetically, by creation date, or by other stored file attributes (e.g., size, type, etc). The sorting methods, however, do not allow for optimal file locating. For example, alphabetic sorts will only aid a user in locating a file if the user knows the title of the file that is being sought. Sorts based upon creation data typically fail to show older files that may still be relevant.

Cataloging files into subdirectories or subfolders is one approach that file repository managers have performed to allow for easier file location. This approach, however, is still not an optimal solution to the problems inherent in finding files because it requires manual creation of file folders and, furthermore, requires users to store files in the appropriate locations.

In addition to shortcomings of existing file management techniques in the ability for users to locate files, file cleanup (e.g., archiving and/or deleted unwanted files) in a shared repository is typically not an efficient process. It is often the job of the file repository manager to cleanup the repository by organizing the files into various archives and deleting unnecessary files. The file repository manager, however, often has no basis for determining which files are no longer needed. As a result, the cleanup process often falls to the individual users, and, more often than not, is not performed at all. Thus, file repositories often become crowded with obsolete files, making the task of locating relevant files more difficult and increasing storage costs.

Exemplar Computing Environment

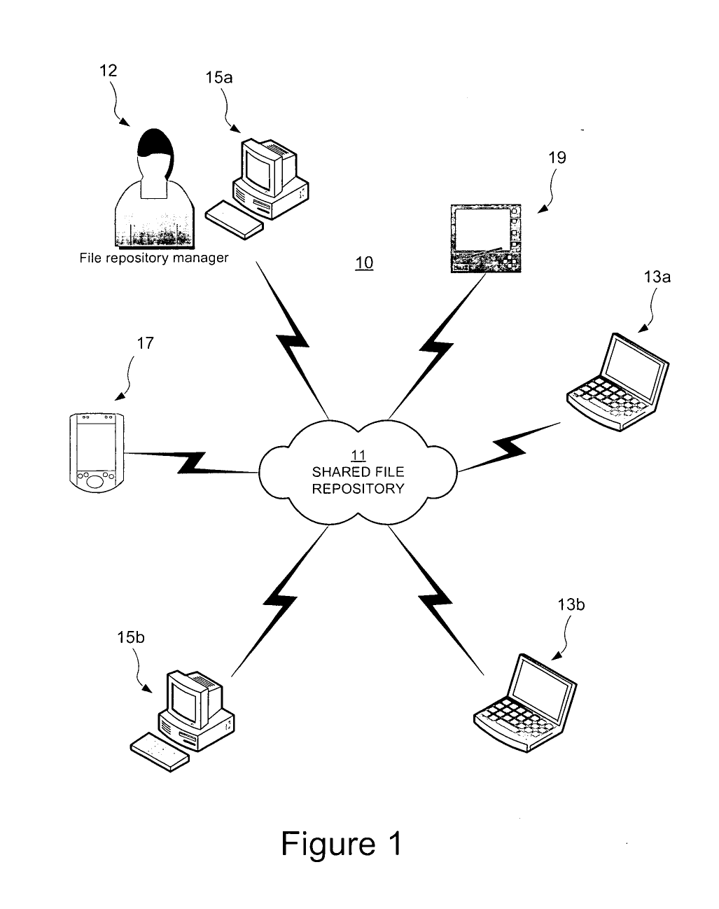

A typical distributed network system is illustrated in FIG. 1. The network shown in FIG. 1 provides an exemplary computing environment upon which the present invention can operate. A distributed network 10 comprises a plurality of devices for allowing user access to the network 10. Devices such as laptop computers 13a, 13b, desktop computers 15a, 15b, personal data assistants 17, and digitizing tablet 19 each can provide user access to a shared file repository 11. Typically, each device contains a processor and memory capabilities for running an operating system that includes the ability for storing and/or accessing files. Such operating systems are well known in the art. Alternatively, the processor, memory, and operating system can reside on a server upon which the shared file repository 11 resides, or a separate server in communication with network 10. The access devices shown in FIG. 1 are by way of example only, as other types of devices can also be used to access the file repository 11. This type of network system is often used by department or project teams to allow each team member access to the work of other team members.

The shared file repository 11 typically resides on a file server. An individual is typically responsible for managing the file repository, referred to herein as a file repository manager 12. The file repository manager 12 typically configures the shared file repository 11, for example, by allowing particular users to have various levels of access to the repository.

File Management Technique

An exemplary embodiment of the present invention provides a system and method for automatically managing a shared file repository. The embodiment described herein uses a file triage processed based upon a relevance score to display files in a directory or to archive and/or delete unwanted or unnecessary files, as determined by the relevance scoring process.

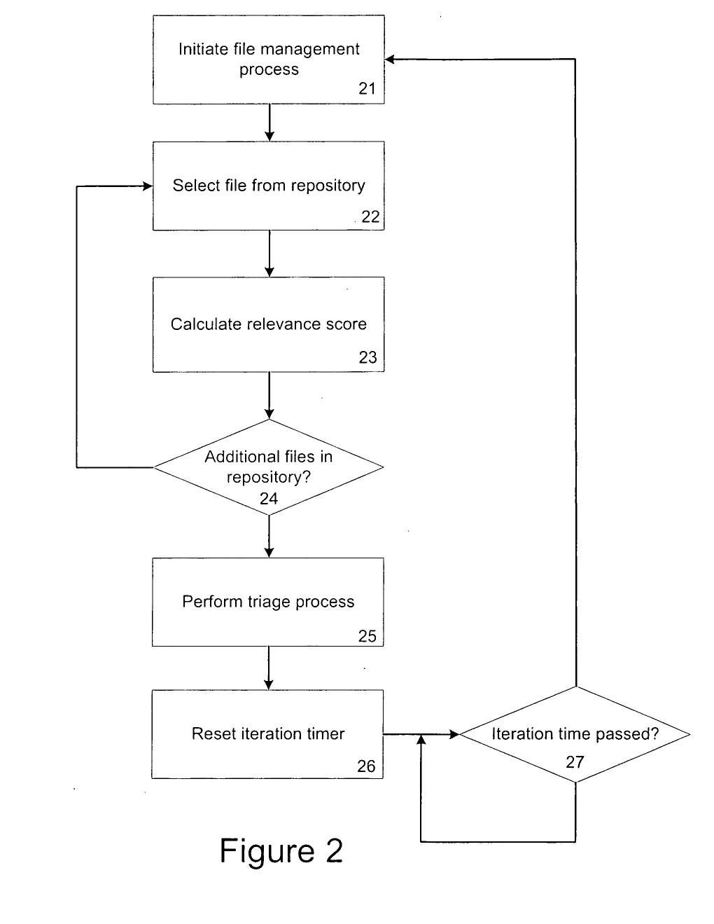

Referring to FIG. 2, a flow chart illustrates the steps involved in performing a file management process on a shared file repository in accordance with an exemplary embodiment of the present invention. When the process is initiated (step 21), a first file can be selected from the repository (step 22). Any number of methods can be used to determine the order by which files are chosen, and these methods would be apparent to one of skill in the art. The order for selecting files from the repository is typically not of great importance, since a complete cleanup of the repository will typically include applying the management process to all files in the repository.

After a file is selected, a relevance score can be calculated for the selected file in accordance with factors that can be predetermined by a file repository manager (step 23). In the exemplary embodiment described herein, the system uses three factors to calculate the relevance score. A first factor is representative of file age. This factor can be a numerical indication of the time elapsed since the creation of a file (or since it was first stored on the shared repository) and the current time. Typically, the age of a file is measured in days.

A second factor is representative of file access. This factor can be a numerical indication of the number of times the file has been accessed, but not modified, in a predetermined time period. The predetermined time period can be determined by the file repository manager, and will likely depending upon the types of files stored in the repository and the number of users of the repository. For example, in some cases, it might be desirable to use the total number of times the file has been accessed since its creation. In other cases, however, such as in a repository for a project for which files tend to be accessed very frequently for short periods of time and then go stale and are rarely accessed again, a more meaningful value might be obtained by using the number of times the file has been accessed in a predetermined time (e.g., the past month).

A third factor can be representative of file modifications. This factor can represent a numerical indication of the number of times the file has been modified (e.g., a change or edit has been made) in a predetermined time period. A modification to a file tends to indicate ongoing use or work to the file, which in turn is indicative of the importance of the file. An access of a file might simply be a user opening a file and determining that it is not the file he or she is seeking, but a modification is more likely indicative of a file that is active and should remain in the repository.

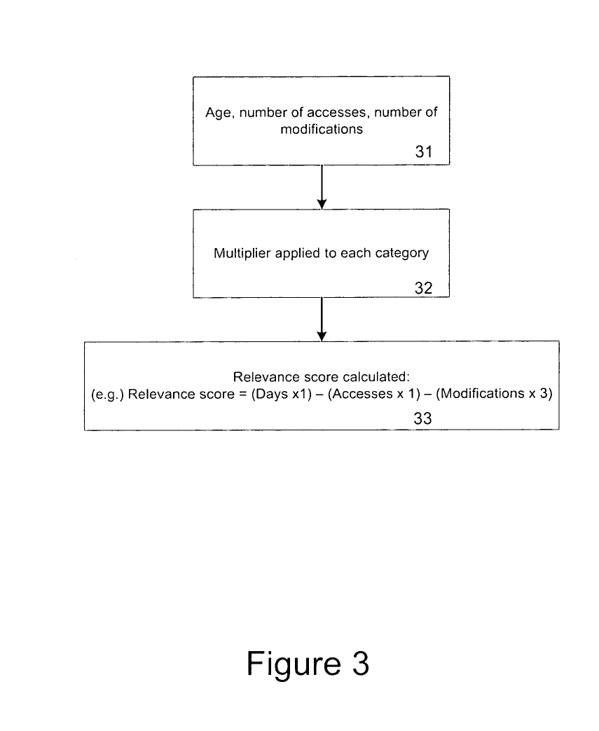

The relevance score can be calculated using these three factors. An exemplary embodiment of the calculation process is further described herein with reference to FIG. 3. Referring to FIG. 3, a relevance score for a file is calculated by making a determination of the three factors (age, number of access, number of modifications) (step 31). A multiplier can be assigned to each factor to allow for the factors to be weighted in accordance with the relative importance of each, as determined by the file repository manager during the configuration of the system (step 32). For example, a file repository might be used for a project that changes rapidly, indicating that files that have received little attention in recent days are likely of less interest. In such a case, the time period set for considering accesses and modifications might be set to 30 days. A first multiplier of 1 might be used for age and accesses, and a second multiplier of 3 might be used for modifications.

Using the three factors and the multiplier for each, a relevance score can be calculated (step 33). In the exemplary embodiment, the relevance score would be defined according to the following equation:
Relevance score=(age×1)−(accesses×1)−(modifications×3) (Eq. 1)
where:
age=the number of days since creation;
accesses=the number of times the file was accessed in the preceding 30 days;
modifications=the number of times the file was modified in the preceding 30 days.

In the exemplary embodiment, a highly relevant file is indicated by a lower relevance score. For example, using equation 1, a first file created today would have a relevance score of 0 (0 age, 0 accesses, 0 modifications). Such a file is likely to be highly relevant. A second file created 25 days ago that has not been accessed since would have a score of 25 (25 age, 0 accesses, 0 modifications). This file is aging and appears to be of little or declining interest. A third file generated 25 days ago and modified 3 times since the time of creation would have a relevance score of 16 (25 age, 0 accesses, 3×3 modifications). A fourth file created 40 days ago, accessed 12 times and modified 8 times in the first week after creation but not used since that time would have a score of 40 (40 age, 0 accesses, 0 modifications). The file accesses and modifications would not affect the score because the occurred outside of the 30 day time frame preset by the repository manager. In this example, the file appears to have been of interest immediately following creation, but appears to have lost its relevance as time passed.

After a relevance score as been calculated for a file, the score is stored in a memory for use in the selected triage process to be performed after the desired amount of files in the repository have been scored. Generally, all files in the repository will be scored, but this might not always be necessary or desirable. In some instances, it may be sufficient to apply the scoring procedure to less than all files. For example, in some embodiments, the relevance scoring procedure might only be applied to files over a certain size in cases where storage is a concern (e.g., files under a certain size are not a large storage problem, thus they might not be scored each time the management process is performed). Limiting the number of files that are subjected to the file management process can increase the speed in some instances.

In the exemplary embodiment illustrated in FIG. 2, the scoring process is applied to each file in the repository. A determination is made whether additional files exist that have not been assigned a relevance score (step 24). If additional files are present, the next file is selected and the scoring process is repeated.

Once the last file in the repository is reached (or in some cases, the last file desired to be subjected to the file management process), a triage process is performed on the file repository (step 25). The triage process can include sorting, moving, characterizing, archiving, and/or deleting files. For example, the relevance scores can be used to determine how files are displayed in a directory listing. When a user accesses a directory listing of the files in the repository, the files can be sorted using the respect relevance score for each file (naturally, in an embodiment that scores less than all files, the files not scored would not be examined based upon relevance score). Sorting by relevance score would enable the user to locate files likely to be of interest (i.e., more relevant according to the relevance score) more easily. Using the four files described in the example set forth herein, a request for a directory listing would return a list of files with the first file (relevance score=0) listed first, followed by the third file (relevance score=10), followed by the second file (relevance score=25), followed by the fourth file (relevance score=40).

In addition to sorting for directory listings solely by relevance score, the triage process can be configured to group files of similar relevance scores into categories and to further include secondary and tertiary sorting with each category. For example, the system can be configured to group files into a highly relevant category (e.g., relevance scores less than 10), a moderately relevant category (e.g., relevance scores greater than 10 but less than 30), and a less relevant category (e.g., relevance scores of 30 or more). Once the files are assigned to a category, classical sorting (e.g., alphabetically) can be applied within a category. Thus, the directory listing shown to the user would list the highly relevant files in alphabetical order first, followed by the moderately relevant files in alphabetical order next, followed by the less relevant files in alphabetical order last. Alternative display techniques could also be used to display the files, while still conveying the relevancy information to user. For example, a traditional alphabetical directory listing might be used for all files with the highly relevant files shown in a different font or different color from the other files.

The triage process (step 25) can also include an archiving and/or deleting process. For example, files with a relevance score above a particular threshold might be moved into an archive file and deleted from the repository. Alternatively, the file might simply be deleted without archiving; however, in such embodiments, it might be beneficial to include a waiting period between marking files for deletion and actual deletion. During the waiting period, the file owner can be automatically notified (e.g., via an email message) so that he or she can make a copy of the file before it is lost. Alternatively, in other embodiments, warnings could be provided to file owners for files that have relevance scores nearing the deletion threshold (e.g., beyond a predetermined warning threshold, but not yet past the deletion threshold). The file owner could access and/or modify the particular file if he or she chooses such that the file's relevancy score will be improved upon the next application of the file management process.

The management process is performed periodically on intervals determined by the file repository manager, referred to herein as an “iteration” time. After the triage process is performed, a timer used to measure the iteration time is reset to zero, which indicates that the process has just been completed (step 26). A waiting period ensues until the iteration time has passed (step 27), and then the process can be repeated.

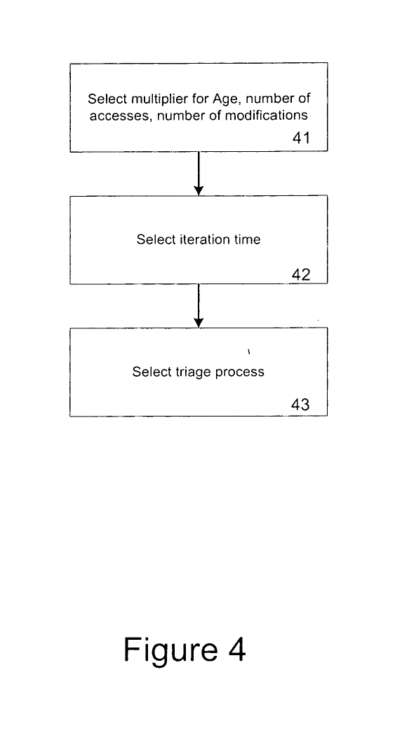

The system can be configurable to allow the file repository manager to set the system parameters for optimal performance on a particular file repository. For example, the steps involved in an exemplary configuration process are shown in FIG. 4.

The file repository manager can choose the multiplier for each of the three factors used to calculate the relevance score (step 41). This also allows the file repository manager to configure the system to calculate the relevance score based upon less than all three factors by simply using a factor of zero for any one of the three criteria. Additionally, the predetermined time period that is used to evaluate the factors (i.e., the time in which accesses and modifications are scored) can be set by the file repository manager. This time period is typically measured as a number of days.

The iteration time for evaluating the various factors and performing the cleanup process can be selected by the file repository manager (step 42). Typically, the iteration time will be chosen based upon the activity level that might occur within a given shared file repository. For example, a shared file repository that is used sporadically by only a few users might be configured to have an iteration time of a month, while an iteration time of one day might be used for a heavily used file repository.

The system is capable of performing various types of automatic triage actions. The file repository manager can configure the system to provide one or more triage options (step 43). For example, the triage action can include sorting files for display in a directory listing, archiving files to a archive or back-up location, deleting files from the repository, or any combination of these actions. Additionally, the file repository manager can select the types of warnings, if any, to be provided to the file owners.

Once the configuration values have been selected by the file repository manager, the system is ready to perform the selected triage actions. Alternatively, default values can be used for one or more of the criteria, thus reducing the amount of configuration needed by the file repository manager.

The system and method described herein provides file repository managers with considerable flexibility in managing the content of the repository while alleviating the concerns caused by repositories that are disorganized and crowded with obsolete files. The often used and likely relevant files are easily located by repository users, thus increasing the efficiency of whatever project team might be using the repository.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. An method for file management comprising:
calculating a relevance score for each file of a plurality of files in a file repository; and
performing a triage process on said plurality of files in accordance with said score.

2. The method as set forth in claim 1, wherein said calculating step comprises:
measuring a plurality of factors for each file of said plurality of files; and
calculating said relevance score based upon said factors.

3. The method as set forth in claim 2, wherein said factors comprise accesses, modifications, and file age.

4. The method as set forth in claim 1, wherein said calculating step comprises
assigning a first value corresponding to an age of a file;
assigning a second value corresponding to a number of times a file has been modified;
assigning a third value corresponding to a number of times a file has been accessed; and
generating said relevance score based upon said first, second, and third values.

5. The method as set forth in claim 4, further comprising applying a multiplier to each value.

6. The method as set forth in claim 1, wherein performing said triage process comprises providing a list of said plurality of files in said repository to said user in accordance with said relevance score.

7. The method as set forth in claim 1, wherein performing said triage process comprises identifying files wherein said relevance score exceeds a predetermined threshold and archiving said identified files.

8. The method as set forth in claim 1, wherein performing said triage process comprises identifying files wherein said relevance score exceeds a predetermined threshold and deleting said identified files.

9. The method as set forth in claim 1, wherein said file repository is a shared file repository.

10. The method as set forth in claim 2, wherein said factors are predetermined by a file manager for a shared file repository.

11. The method as set forth in claim 1, wherein said method is repeated upon expiration of a predetermined iteration time period.

12. The method as set in claim 8, further comprising providing a notice to a user prior to deleting said identified files.

13. The method of claim 1, wherein said plurality of files comprises all files in said repository.

14. A system for file management comprising:
a file repository having a plurality of files stored in said repository;
a processor, said processor capable of:
calculating a relevance score for each file of said plurality of files; and
performing a triage process on said plurality of files in accordance with said score.

15. The system as set forth in claim 14, wherein said calculating by said processor comprises:
measuring a plurality of factors for each file; and
calculating said relevance score based upon said factors.

16. The system as set forth in claim 14, wherein said factors comprise accesses, modifications, and file age.

17. The system as set forth in claim 14, wherein said calculating comprises
assigning a first value corresponding to an age of a file;
assigning a second value corresponding to a number of times a file has been modified;
assigning a third value corresponding to a number of times a file has been accessed; and
generating said relevance score based upon said first, second, and third values.

18. The system as set forth in claim 14, wherein said triage process comprises providing a list of said plurality of files in said repository to said user in accordance with said relevance score.

19. The system as set forth in claim 14, wherein said file repository is a shared file repository.

20. A computer program product comprising a computer useable medium having program logic stored thereon, wherein said program logic comprises machine readable code executable by a computer, wherein said machine readable code comprises instructions for:
calculating a relevance score for each file of a plurality of files in a file repository; and
performing a triage process on said plurality of files in accordance with said score.

21. The computer program product as set forth in claim 20, wherein said instruction for said calculating step comprise instructions for:
measuring a plurality of factors for each file; and
calculating said relevance score based upon said factors.

22. The computer program product as set forth in claim 20, wherein said instructions for said calculating step comprise instructions for:
assigning a first value corresponding to an age of a file;
assigning a second value corresponding to a number of times a file has been modified;
assigning a third value corresponding to a number of times a file has been accessed; and
generating said relevance score based upon said first, second, and third values.

23. A system for file management comprising:
means for calculating a relevance score for each file of a plurality of files in a file repository; and
means for performing a triage process on said plurality of files in accordance with said score.

24. The system as set forth in claim 23, wherein said means for calculating a relevance score comprise:
means for measuring a plurality of factors for each file; and
means for calculating said relevance score based upon said factors.
